(19) United States
(12) Patent Application Publication
(10) Pub. No.: US 2010/0033403 A1
(43) Pub. Date: Feb. 11, 2010

(54) PORTABLE MONITOR DISPLAY

(75) Inventor: Eric Liao, Mississauga (CA)

Correspondence Address: PERKINS COIE LLP, P.O. BOX 1208, SEATTLE, WA, 98111-1208, US

(73) Assignee: MEDL Technology Co., Ltd., ShenZhen (CN)

(21) Appl. No.: 12/506,902

(22) Filed: Jul. 21, 2009

Related U.S. Application Data
(60) Provisional application No. 61/136,050, filed on Aug. 8, 2008.

(51) Int. Cl. G09G 5/00; G06F 21/00

(52) U.S. Cl. 345/2.1; 726/17

(57) ABSTRACT

Methods and systems for use of a portable monitor display (PMD) are provided. In one embodiment, the PMD is used selectively either as a remote monitor or as a dual monitor to a computer based on a distance between the computer and the PMD. In one embodiment, the PMD is used to provide secure access to a computer server. In one embodiment, the multiple PMDs communicate with a given computer to provide a conference and/or shared operation setting. In one embodiment, the PMD is used as a visual remote controller for one or more media devices.

### CROSS REFERENCE TO RELATED APPLICATIONS

This application claims priority to and includes by reference provisional application No. 61/136,050, entitled “Portable Monitor Display (PMD) for Electronic Devices,” filed on Aug. 08, 2008.

### FIELD OF THE INVENTION

At least one embodiment of the present invention pertains to electronic display monitors, and more particularly, to a portable monitor display for use in electronic applications.

### BACKGROUND

Display monitors give life and form to computing and/or mobile devices - they enable a user to view information output by a computer and also enable the user to visualize information entered by the user to the computer. A computer or a media device, as defined herein, includes, but is not limited to, electronic equipment with processing capability such as laptops, desktop computers, network servers, mobile phones, tablet PCs, entertainment equipment (e.g., Ipod®, home theaters, etc.), etc. Monitors display images generated by such computing and/or media devices, without producing a permanent record. A monitor comprises the actual display device, circuitry, and an enclosure. While older monitors used cathode ray tubes as display devices, modern monitors use liquid crystal display (LCD) or Light Emitting Diode (LED) technologies to create compact display units.

Desktop monitors come in a variety of sizes and allow people to view images with ease. However, in a mobile computing scenario, the monitors are either too small or are too bulky to carry around. Laptops come with larger sized monitors, however, they also come with the burden of the additional weight and inconvenience introduced due to the processing and storage elements associated with the laptop. Additionally, when the laptop gets stolen or damaged, any secure data stored in the laptop may be lost or compromised.

When using mobile computing devices such as laptops or mobile phones, a user may wish to use an additional monitor to increase efficiency and ease of operation. Currently, such an additional monitor is in the form of a CRT or LED monitor that does not lend itself to portability. The additional monitor is usually a stationary and bulky monitor at the user's desk. The user connects his mobile computing device through, for example, a docking station when he has to use the additional stationary monitor. However, when the user is on the move (e.g., working from a conference room, working in a temporary office or a library, etc.), he is unable to carry an additional monitor and is therefore forced to work with the sole monitor inherent to the mobile computing device.

### SUMMARY

Systems and methods for use of a portable monitor display (PMD) are provided. In one embodiment, the PMD includes a display unit that allows a user to both input and view information displayed from a computing station. The PMD may be used as a duplicate monitor (i.e., in a dual-mode operation) in addition to a monitor associated with the computing station, or may be used as a remote monitor to operate the computing station from a remote location. In one embodiment, the PMD dimensions are comparable to that of a laptop to enable easy portability of the PMD in a laptop bag. In some instances, the processing and storage capability of the PMD is limited to providing input and output functionality. The PMD does not have other bulky circuitry or elements required for full fledged computing operations, and so are not as heavy as, for example, laptops or tablet PCs. In one embodiment, the PMD includes a communication component to enable the PMD to remotely communicate with a computing station. The processing of information input or output through the PMD is carried out by the computing station, while the PMD functions as an input/output device.

Such a PMD is useful in a variety of applications. In one embodiment, the PMD includes a security component to allow the PMD to be used for secure access of a computing server (or other computing devices). In one embodiment, multiple PMDs are configured to remotely operate based on a single computing station, allowing several remote operation capabilities (e.g., hospital settings where medical records are stored in a central computer, conference type of setting to share displayed images, etc.). In one embodiment, two PMDs may be arranged in a hinge assembly to provide a laptop type of arrangement (without directly having the processing power or the bulkiness of a laptop). In one embodiment, the PMD is used selectively as either a remote-mode device or as a duplicate-mode device to a computing station. In such an embodiment, in some instances, the PMD includes a proximity sensing capability to switch between the two modes of operation depending on a distance between the PMD and the computing station.

In one embodiment, the PMD is used as a visual remote controller to control and operate one or more media devices (e.g., TV, computer, home entertainment system, etc.). The PMD receives visual input of both the images displayed by the media devices and also applicable control features, enabling a user to remotely control the devices based on information displayed in the PMD.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

One or more embodiments of the present invention are illustrated by way of example and not by limitation in the figures of the accompanying drawings, in which like references indicate similar elements and in which:

FIG. 1 illustrates an exemplary architecture of a PMD and a representative environment in which the techniques described herein may be implemented;

FIGS. 2A-2E show exemplary representations of a PMD that can be used for implementing the techniques described herein;

FIG. 3A-3C depict various usage representations of a PMD;

FIGS. 4A-4B illustrate different usage setup examples for using a PMD;

FIG. 5 is a representative environment in which the PMD may be used as a remote controlling device;

FIG. 6 is an exemplary embodiment of a desktop/laptop setup built using two PMD devices; and

FIG. 7 is a flow diagram depicting an exemplary process by which a PMD can be used to switch between remote and duplicate modes of operation.

### DETAILED DESCRIPTION

References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

### Architecture and Structural Features of a PMD

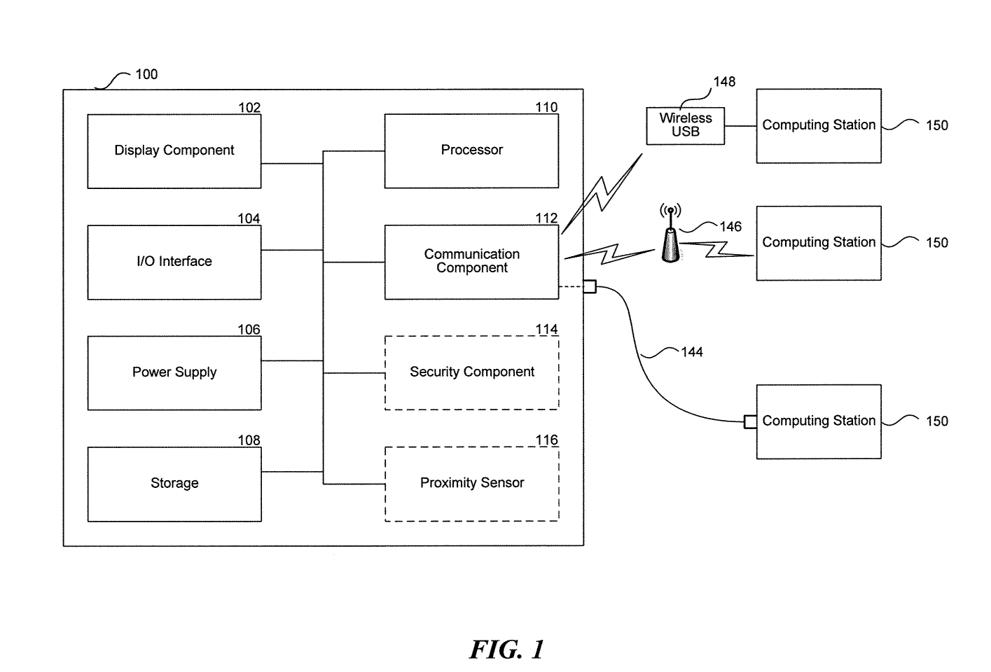

FIG. 1 illustrates an exemplary architecture of a PMD 100 and a representative environment in which the techniques described herein may be implemented. In one embodiment, the PMD 100 includes a display component, which, in some instances, covers a substantial portion of a front side of the PMD 100. In one embodiment, the display component is a touch screen, allowing users to view information through, for example, an LCD or LED display, and to input information using the touch-screen feature of the display component. The PMD 100, in some instances, includes a processor 110 (e.g., an ARM processor) that is useful for performing logic functions pertinent to intelligent display of information displayed through the display component. In some instances, for example, the processor 110 enables a user of the PMD 100 to switch the PMD 100 from a dual-display mode to a remote display mode. Such modes are described in detail in subsequent sections of this description. In other examples, the processor 110 is useful for enabling the PMD 100 to establish communication with a remote computing station (e.g., 150). In another example, the processor 110 is useful for enabling a user of the PMD 100 to switch between or among multiple displays received from the computing station (e.g., switch from a display containing English-language content to a display containing Spanish-language content, where both such displays are received by the PMD 100 from a computing station). In other examples, the processor 110 controls the touch-screen capability of the display component 102 and manages the information entered by a user for subsequent transmission to a receiving computer (e.g., computing station 150).

In one embodiment, the PMD 100 includes an I/O interface 104 to enable a user of the PMD 100 to input information through the PMD 100. For example, the I/O interface 104 includes the touch-screen capability of the PMD 100. In another example, the I/O interface 104 includes a pointing device (e.g., a track ball mouse, etc.) attached to the front portion of the PMD 100.

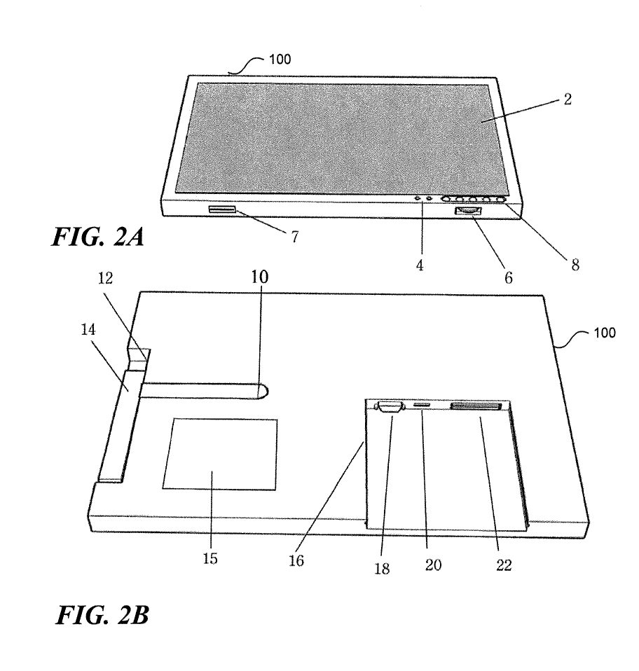

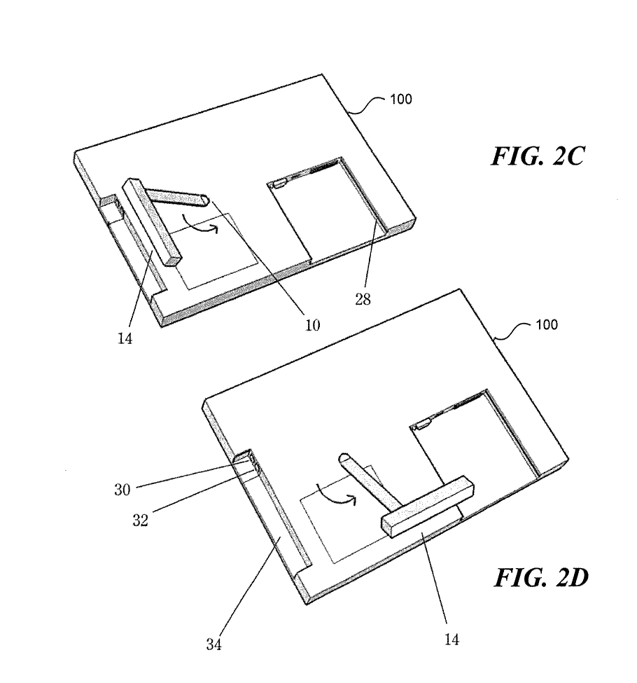

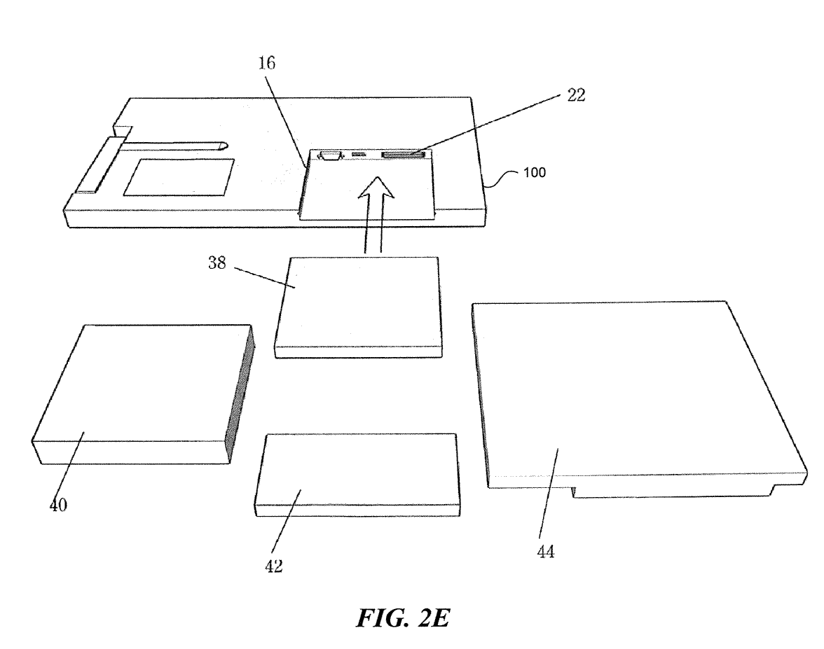

The PMD 100 operates using power regulated by the power supply component 106 of the PMD 100. The power supply component 106 derives and regulates power from an AC power unit (e.g., an AC power outlet, an AC power generator machine, etc.), or from a DC power source, or in some instances, from a battery. Additional details on the power supply regulation for the PMD 100 are explained with reference to FIGS. 2A-2E below.

In some instances, the PMD 100 includes a communication component 112 to enable the PMD 100 to receive or transmit information, for example, to a computing station 150. In one example, the communication component 112 enables the PMD to wirelessly transmit information or receive information to/from a computing station 150. In such an example, the communication component 112 may communicate using a wireless protocol (e.g., wireless USB 148) to communicate with a protocol-compliant feature of the computing station 150. In one example, the communication component 112 may use a mobile communication protocol (e.g., 146) to establish wireless capability, where such capability includes, but is not limited to, voice and data communication capabilities in accordance with technical standards such as GSM, CDMA, TDMA, UMA/GAN, capabilities conforming to 3G standard for mobile networking, Bluetooth® technology, WiMAX, etc. In one example, the communication component may use a wired interface 144 to communicate with a remote computing station 150. A “remote” station, as used herein, refers to any computing device that is configured to receive information from the PMD 100 or transmit information to the PMD 100 using a wireless or wired mechanism. In addition to the above mentioned examples, it is understood that other means of remote communication between the PMD 100 and a computing station 150, as understood by one of ordinary skill in the art, are suitable for use in the PMD 100 described herein. In one embodiment, the communication component 112 may also include a TV tuner (not shown in FIG. 1) to enable the PMD 100 to receive and display TV broadcast signals.

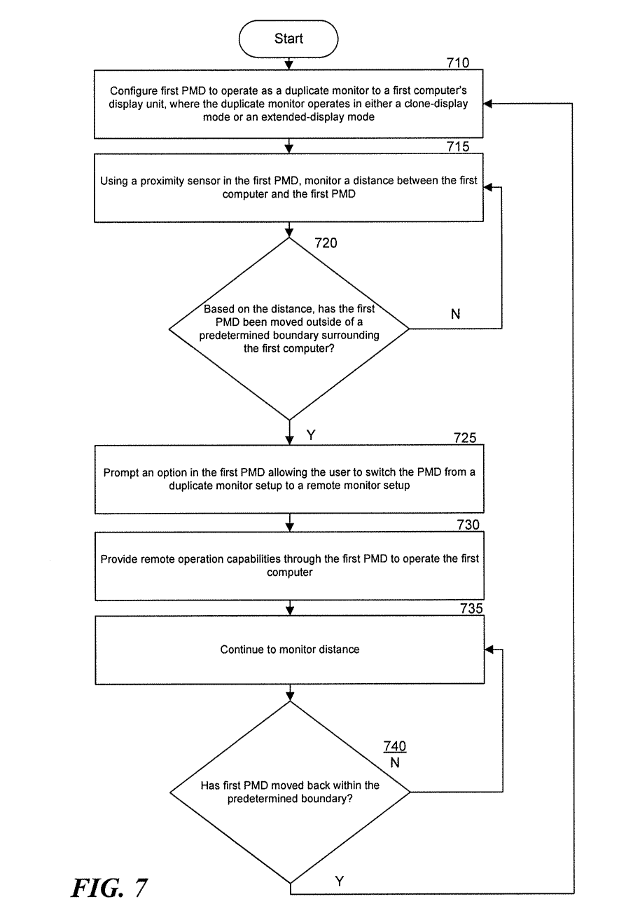

In some instances, the PMD 100 includes a storage component 108. While the PMD 100 may communicate with a computing station 150 to predominantly operate (receive or transmit) on information stored in a computing station 150, the local storage component 108 may be useful for a variety of purposes. In one example, the local storage component 108 is used by the I/O interface (e.g., the touch screen feature) to temporarily cache information input by a user before transmitting the information using the communication component 112. In other instances, the local storage component 108 may store an operating system software or other software useful for various executory and management operations within the PMD 100. The software, for example, provides options to allow a user to select either a dual mode display or a remote display. In another example, the software stored in the storage 108 communicates with the processor 110 to execute the various operations of the processor 110. In other examples, the software monitors data received from a proximity sensor 116 to enable the PMD 100 to perform various intelligent functions. For example, the software determines whether the PMD 100 is within an “active range” of a computing station 150 and alters the display output options accordingly. Such an example is described in detail with reference to FIG. 7 below.

FIG. 2A shows an exemplary representation of a PMD 100 that can be used for implementing the techniques described herein. In one embodiment, the front side of the PMD 100 consists of an LCD screen 2, one or more buttons 8 to control various operations, and LED indicators 4 located along the bezel. In some instances, the PMD 100 includes a multi-purpose scroll wheel 6 (e.g., along the bottom portion) and a memory card reader 7. The buttons 8, LEDs 4 and scroll wheel 6 may be used when the PMD 100 is functioning as a dual-mode display (either in a clone mode or an extended display mode) or when the product is being used as a stand alone device. In one embodiment, the PMD includes a battery unit (not shown in FIG. 1) that allows the PMD to optionally operate without the need of an external power supply.

FIG. 2B illustrates an exemplary representation of the rear-view of the PMD 100. In one embodiment, the PMD 100 includes different electrical sockets including, for example, a 15 pin VGA socket 18, a USB socket 20, a multi-pin multi-purpose connector 22, etc. In some instances, especially where a laptop uses the PMD 100 as a second monitor (i.e., as a duplicate or a dual-mode monitor), the PMD 100 transmits video data primarily through the VGA socket 18. Other auxiliary data may be transmitted through the USB socket 20 or wirelessly through a wireless protocol such as Bluetooth (as explained above with reference to FIG. 1). The purpose of the multi-pin multipurpose connector 22 is for connectivity to any add-in modules. The multi-pin multi-purpose connector 22 is adapted to support different electrical transmission standards (e.g., USB, video, audio, power, etc.).

In some embodiments, the back side of the PMD 100 has an open space for an add-in module dock 16. This dock allows a standard module 38 or other sized modules to slide into the PMD and use the LCD screen 2 as a primary or secondary display. In some instances, the power for the PMD is supplied through a power input/output socket 12 located on the side of the device. In some examples, a support leg 14 is attached to a multi-positional hinge 10. Additionally, in some examples, a multi-positional hinge 10 is mounted on the back side of the PMD 100. The multi-positional hinge 10 allows the support leg 14 to move in different dimensions. In some instances, a removable external battery 15 may be used in conjunction with the internal battery to further extend the battery life of the PMD 100.

FIG. 2C illustrates an embodiment of the PMD 100 where the support leg 14 is positioned for portrait mode. Modules may be inserted into add-in module dock 16 with a support groove 28 to provide additional mechanical support.

FIG. 2D illustrates an embodiment of the PMD 100 where the support leg 14 is positioned for landscape mode. When the support leg is not used, it rests in a support leg resting space 34. In one embodiment, the PMD 100 has a unique feature that allows a power supply to connect through an input power socket 30. In such an embodiment, a subsequent cable may be connected from an output power socket 32 to the laptop, thus providing power to the laptop and the PMD 100 at the same time.

FIG. 2E depicts an embodiment of the PMD 100 with the different modules that may be inserted in the add-in module dock 16. A standard size module 38 will fit into the PMD where the edges of the module align with the edges of the PMD, thus showing no protrusions. Additional module sizes include, for example, a double size module 40 that is twice the height of the standard size module 38, a mini size module 42 that is half the length of the standard size module 38, a jumbo sized module 44 that covers much (e.g., two thirds) of the back side of the PMD 100, etc. The functionality of the module determines the size of the module. Such functionalities may include operations of, for example, a DVD player, GPS, Ipod® adaptor, PDA, ebook/document reader, battery pack, etc. Other functionalities, as understood by a person of ordinary skill in the art, may also be contemplated for use with the PMD 100 described herein. In some embodiments, the modules interface with the PMD 100 via multi-pin multi-purpose connector 22.

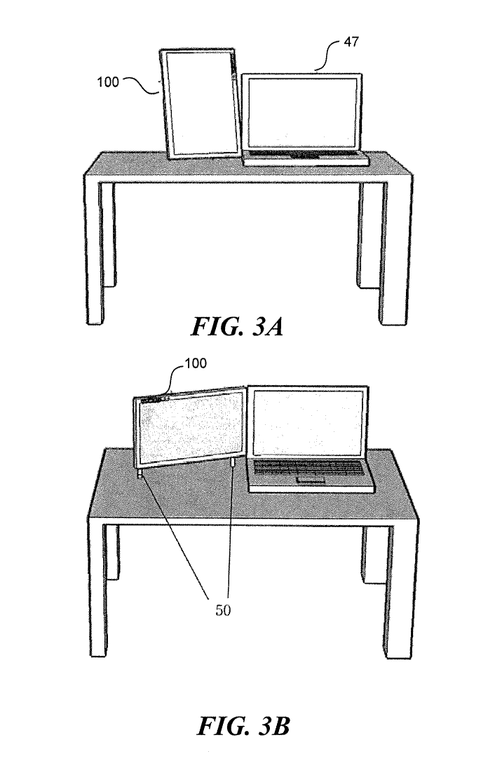

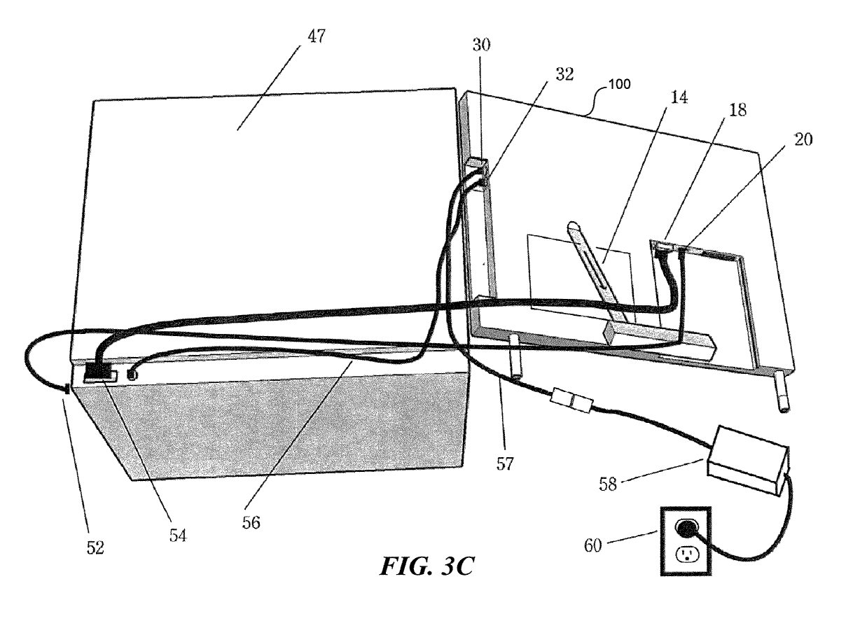

FIG. 3A depicts an embodiment of the PMD 100, where the PMD 100 is setup beside a regular laptop 47 as a secondary monitor display (i.e., a dual-mode display) in portrait mode. The dual-mode display may either be in a “clone-display” mode or an “extended-display” mode. As described herein, a clone-display mode refers to an instance where the primary monitor and the secondary monitor display identical information. An extended display, on the other hand, refers to an instance where the two monitors are able to display non-identical information, where one monitor behaves as an extension of the other monitor.

FIG. 3B depicts an embodiment of the PMD 100, where the PMD 100 is arranged beside a regular laptop 47 as a dual-mode monitor display in landscape mode. Adjustable leg extenders 50 extend out of the PMD 100 and allow the PMD to be positioned at a custom height to enable the PMD 100 to align with the display of regular laptop 47.

FIG. 3C illustrates a configuration for connecting the PMD 100 with a regular laptop 47. In one embodiment, a support leg 14 is adapted to extend such that the support leg 14 is longer, allowing the PMD to be positioned at different viewing angles. USB cable 52 connects from the laptop's USB socket 52 to the PMD's USB socket 20. A VGA cable 54 connects the laptop VGA socket 54 to the PMD's VGA socket 18. The PMD 100, in some instances, receives power via a power supply 58 that connects to a custom power cable 57 and then to an input power socket 30. Power supply 58 is powered via a common AC wall socket 60 (or other means of power supply as understood by a person of ordinary skill in the art). Power supply 58, can either be a power supply included with the laptop 47, a power supply included with the PMD 100, or another third-party power supply.

In some embodiments, a custom power cable 57 may be used if the user decides to draw power using the laptop's inherent power supply or using a third party power supply. Since different laptop power supplies use different connectors, custom power cable 57 facilitates connection among the power elements. In some embodiments, an output power cable 56 connects to output power socket 32 that can then power the regular laptop 47. Such a setup is supported when power supply 58 has enough power to support both the PMD 100 and the laptop 47. Alternately, in some instances, if there is insufficient power from the power supply 58, power for the PMD 100 and the laptop 47 may be drawn from their respective power supplies.

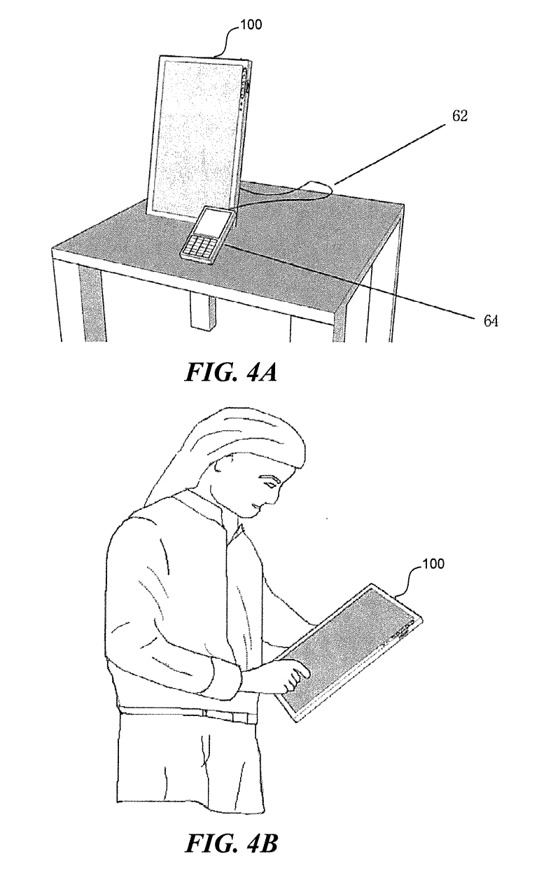

FIG. 4A depicts an exemplary setup where a PDA/mobile device 64 is connected to the PMD 100 via an interface cable 62. In one embodiment, the interface cable 62 connects to the PMD 100 via the multi-pin multi purpose connector 22. FIG. 4B depicts a scenario where the PMD 100 is used as a stand alone device (i.e., it is not used as a duplicate or dual-mode monitor). As illustrated with reference to FIG. 4B, the stand-alone monitor is either a PMD 100 with a module inserted in the back allowing added functionality, or a portable monitor (i.e., a PMD) that is remotely connected to a computer.

The foregoing discussion provided an exemplary structure and composition of a PMD for use in various embodiments. The following sections describe selected embodiments through which a PMD may be operated. It is understood that the following list of embodiments is provided for the purpose of illustrating the functionalities associated with a PMD, and are not intended as an exhaustive list of applications.

### Operational Features of a PMD

The PMD described above is convenient in size and weight so that it can be easily transported from one location to another. In some embodiments, the PMD is configured such that it is convenient enough to fit in the same space as a regular laptop (e.g., fit within a conventional laptop bag, etc.). Most current LCD monitors are too large and not shaped for easy packing and transport. However, the PMD is durable enough to survive the rigors of travel: travel requires a device that can endure constant packing and unpacking, have durable surfaces and withstand knocks and bumping around. Most current LCD monitors are not durable enough for travel. For example, they typically lack a protective cover for the fragile LCD. The PMD has a battery unit built inside that can allow the user to use the screen without an external power supply. Current LCD monitors lack an internal battery unit. The PMD provides a convenient expansion dock/connector that allows a user to connect other electronic devices to the display instead of a computer or laptop. In one embodiment, this kind of feature is largely done using add-in modules that can be placed into an expansion dock. Current LCD monitors facilitate connection only to a computer.

In one embodiment, the PMD has a power supply design that allows it to be recharged using the external power supply of a laptop, thereby allowing the user to carry only one power supply when traveling. This is a major convenience factor not found in current LCD monitors. In one embodiment, the PMD also incorporates a touch screen for pen input and/or pressure sensitive input. Current LCD monitors lack the touch screen ability.

The PMD achieves its result by being a portable and convenient solution for laptop users that want the dual screen setup experience wherever they go. The PMD is much lighter than current LCD monitors and also includes a battery built inside. The built in battery allows users to go wherever they want and still use the PMD without the need of a power supply. In one embodiment, the PMD uses, for example, LCD technology commonly used for laptops. This allows the design to be thinner, lighter, and easier to handle than a traditional desktop monitor.

Because of the simple and light weight design, the monitor can easily be used in either landscape or portrait mode. Additionally, the PMD may be easily adjusted for different viewing angles. Traditional monitors typically do not support the ability to switch between portrait and landscape mode and do not have the ability to change the viewing angle. With touch screen ability, the PMD can be used to transform a regular laptop into a Tablet PC. The PMD's portable size and light weight allows users to use it like a Tablet PC to enter written data and draw pictures. The PMD also adds a further convenience that allows the user to power both the PMD and laptop with a single power supply.

In one embodiment, the PMD can also be used to display information and electronic content via the add-in module dock 16. Modules such as standard module 38 can be designed to interface with electronic devices such as GPS units, media players and PDAs. This allows users to view content on a much larger screen rather than using the small built-in screen on the electronic device. In one embodiment, the module can be an electronic device itself that is used in conjunction with the PMD. For instance, a module can be designed to view PDF documents. In such an embodiment, the module itself will not have a screen but will rely on the PMD to display the content.

When the PMD is used as a standalone device, in some instances, its usage resembles the usage of a Tablet PC. All these modules and devices communicate with the PMD via the multi-pin multi-purpose connector 22. When the PMD is used as stand-alone device with a module attached, the module can access memory card reader 7 for data storage.

### Use of a PMD as a Security Feature

In one embodiment, the PMD 100 includes a security component (114 of FIG. 1). In some instances, this security component 114 is a hardware feature (e.g., hardware lock, optical sensors, etc.). In an illustrative embodiment, this security component 114 may be utilized to use the PMD 100 for a secure computing application. Consider the scenario of a computer server (e.g., 150) placed in a server room. In such a scenario, the PMD 100 is the only display monitor through which a user can gain access to operating functions of the server (e.g., to make configuration changes, to execute programs, to monitor programs running in the server, etc.). Here, the PMD 100 is configured as a “removable” or “pluggable” component of the server. In one example, the PMD 100 may have a docking capability (not shown in FIG. 1) to enable the PMD to be docked into a docking station in the server. In another example, the PMD may be connected through a serial (e.g., VGA) cable to the server.

In some instances, the PMD 100 receives and displays information from the server only when the security component 114 of the PMD 100 matches with the security feature of the server 100. In one example, the server (or the PMD 100) may authenticate an identifying feature of the security component 114 (e.g., a bar code, a digital signal, a digital code, etc.) before enabling information from the server to be displayed through the PMD 100. In such a scenario, the server can be accessed only when the PMD 100 with the unique security component is plugged into the server. When the PMD 100 is removed or unplugged, the server cannot be accessed through any other display mechanism.

In some instances, even after unplugging the PMD 100 from a server, the PMD 100 continues to receive selected information transmitted by the server. Such information may include status updates, warning messages, alert messages, review information etc. Therefore, a person holding the PMD 100 may move around or even go out of a server room and still be able to receive messages related to the server. If an alert message pops up, the user may then be able to return to the server room and plug in the PMD 100 back into the server to perform suitable operations on the server. In some instances, when the PMD 100 is unplugged from the server, the PMD 100 may be used in conjunction with another electronic device (e.g., a mobile device, another computer, etc.) to display information from such a device. In such instances, the display received from the server may be displayed in addition to the display of the other electronic device (e.g., a switched display, a partitioned display, a picture-in-picture display, etc.). In this manner, the PMD 100, while acting as the sole monitor for the server, may also be used in conjunction with other devices to increase efficiency of usage of the PMD 100.

In some instances, the PMD 100 may operate as the sole monitor for a plurality of server machines. For example, a number of server machines within a server room operate with one PMD 100. Each server machine displays the information to the PMD 100 only after the PMD 100 is plugged into the server, and after the authentication process is completed based on the security component 114 of the PMD 100. The PMD 100 may include, for example, an identical authentication for each separate server station, or may be configured to include unique authentication mechanisms for each server station.

### Use of Multiple PMDs Connecting to One or More Computing Stations

In one embodiment, multiple PMDs are configured to operate as display units for one or more central computers. Such a setup finds ready application in several scenarios, including, but not limited to the following examples. In one example, several users, each holding a PMD may use the PMDs to share a presentation in a conference type of setting. In such an example, a person using a central computer may share the presentation through the central computer, and the remaining PMDs (which are merely display monitors and are not associated or connected to a computer) receive the presentation and display the presentation in a remote display setup. In such a setting, each individual user may have options to switch, for example, among several language options to view the presentation in a language that he or she desires. The conference setting, as described herein, refers to situations where display from one computer is shared with other users. Examples of such conference settings include conference room meetings, trade shows and fairs, publicity events, marketing events, etc. Other settings where multiple display units may be used to share information, as understood by a person of skill in the art, are also suitable applications.

In another example, the user may use the PMD as a primary monitor with a central computer in his office. However, when the user has to step out to a meeting in another conference room, he can unplug the monitor from the central computer and just carry the PMD to the conference room. The user would still be able to control or operate on the central computer (e.g., monitor programs running on the central computer; continue editing a text document that is stored in the central computer, etc.) using the I/O features (e.g., touch screen feature) of the PMD. The user would continue to receive and transmit information to the central computer from a remote location.

In another illustrative example, the PMD may be used by people in an industrial or hospital setting, where the people are constantly on the move. For example, within a hospital, a doctor or a nurse goes from one examining room to another attending on various patients. With the PMD, the doctor, for example, can connect to a central computer through the PMD. The doctor could input information through the PMD from a remote location to retrieve information or operate on a database stored in the central computer. The PMD does not perform any of the computing operations related to, for example, operating on the database or storing information into the central computer. The PMD is merely a display unit that the doctor uses to enter in information (e.g., enter in a patient's vital statistics) and view information (e.g., pull up patient records) received from the central computer. Several doctors and/or nurses at different remote locations can operate at the same time by using their PMDs with a connection to the central computer.

Because the PMD is a monitor with limited processing capabilities, it is well suited for portability (in terms of weight and design) and convenience. Such factors allow the doctors to move around freely and still have access to the central computer. Additionally, since the PMD does not locally store any information (all information is stored in the central computer), the risk of compromise to secure patient information is avoided in the event that the PMD is stolen or damaged.

### Use of a PMD as a Remote Controller

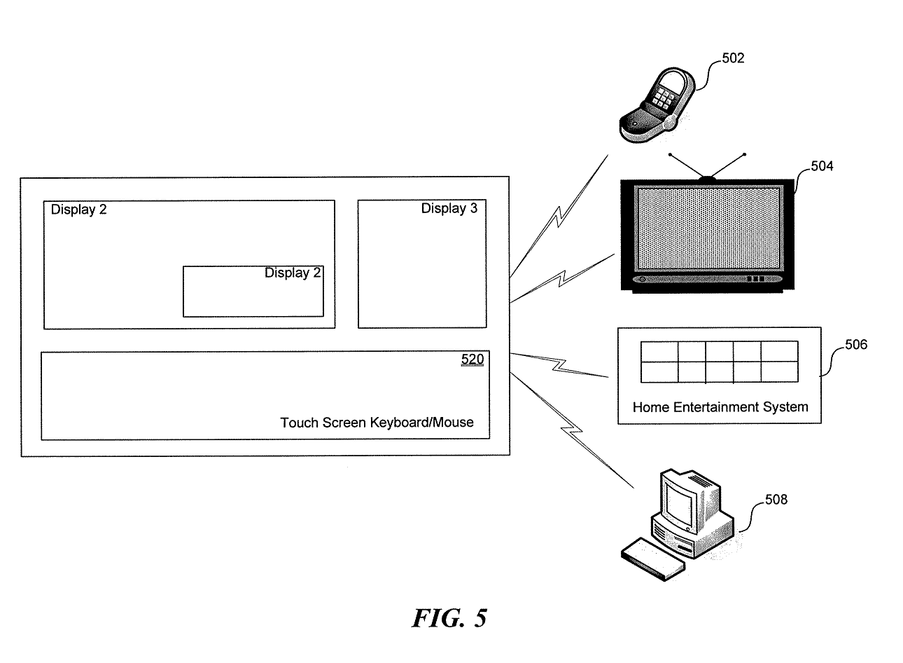

FIG. 5 is a representative environment in which the PMD 100 may be used as a remote controlling device. In one embodiment, a single PMD 100 may be used to connect with a plurality of media devices. As described here, a “media device” refers to electronic appliances that have a display component, including, for example, a mobile device 502, a TV 504, a home entertainment system 506, a desktop computer or a laptop computer 508, a server computer, etc.

The PMD 100 is configured to act as a remote display to one or more of these devices. As referred to herein, a “remote” display refers to an operation of the PMD where the PMD receives information from a media device through the communication component (explained in FIG. 1). Such remote operation includes wired or wireless communication with the media devices. Here, the PMD is used to remotely control the operation of such media devices. For example, as illustrated in FIG. 5, the PMD is configured to remotely control a TV 504, a computer 506, and a home entertainment system 508. The PMD may be partitioned such that a section of the PMD display may be used as an input section (e.g., a touch screen input section 520). The input section 520 can be used by the user to select a particular media device and control the selected media device (e.g., play a song, change channels, start execution of a particular program, etc.). In such a scenario, the control mechanism (e.g., a keyboard of the computer 508, the channel selection menu of the TV 504, etc.) is simulated in the input section, allowing the user to remotely operate the media device.

Additionally, the user may also opt to receive the display of the media device (e.g., the TV display image, the computer image displayed to the computer's monitor, etc.) in the remote PMD 100. In such a scenario, the user may selectively receive the input of a particular media device at a given time, or may choose to have more than one input displayed at the same time. When the user opts to choose multiple inputs in the PMD 100, in some instances, the displays may be compartmentalized within the available screen space of the PMD 100 (e.g., DISPLAY 1 and DISPLAY 3). In other instances, the multiple inputs may be displayed using a PIP (picture-in-picture) feature (e.g., DISPLAY 1 and DISPLAY 2). Other types or adaptations of displays, as understood by a person of skill in the art, are equally suitable for use in conjunction with or in lieu of the techniques described herein.

### Use of Multiple PMDs to Recreate a Laptop/Desktop Experience

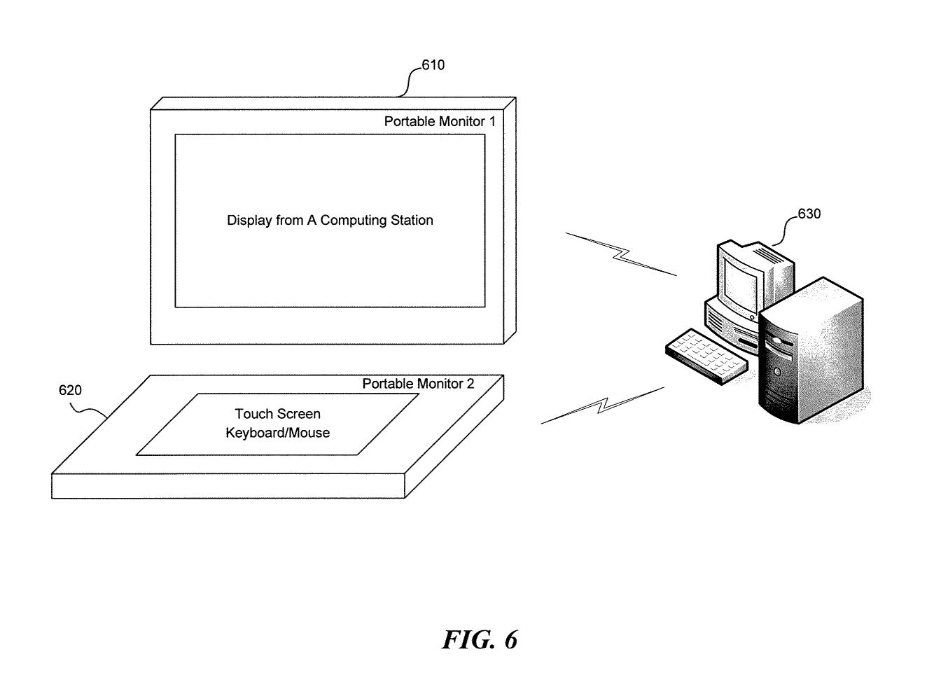

FIG. 6 is an exemplary embodiment of a desktop/laptop setup built using two PMD devices. In some scenarios, especially where multiple people use PMDs to access a central computer, a particular user may want to recreate a laptop type of setup to get a real computer feel. The position adjustment features of the PMD (as discussed above) allow the PMD to be setup in landscape/portrait positions and also in upright/slanted/rested positions. Accordingly, a user may use a first PMD 610 exclusively to receive the display information from the remote computing device 630, and a second PMD 620 to exclusively function as, for example, a touch-screen keyboard setup communicating with the computing device 630. The position adjustment features of the first PMD 610 allows the first PMD to be placed in, for example, a landscape and upright position, while the position adjustment features of the second PMD 620 allows the second PMD to be placed in, for example, a landscape and rested position. Additionally, in one embodiment, a removable hinge assembly or other mechanical assembly (not shown in FIG. 5) may be used to clasp the two PMDs together to give the two PMDs a real laptop type of feel and functionality. In one embodiment, the hinge assembly is provided in conjunction with an add-in module feature of the two PMDs. In such a scenario, the hinge assembly is established by attaching a add-in module to one or both PMDs.

In one embodiment, a similar setup may be derived by using a standard non-portable monitor in connection with a PMD. In such a scenario, the non-portable monitor is configured to perform regular display functions, and the PMD is configured to emulate input/output functions (i.e., keyboard and/or mouse functionality) through, for example, the touch-screen interface of the PMD. The PMD in such a setup is also in remote communication with the central computer 630 to provide the emulation detailed herein.

Real Computer Experience using Multiple PMDs

FIG. 7 is a flow diagram depicting an exemplary process by which a PMD can be used to switch between remote and dual modes of operation. It is understood that the steps described in FIG. 7 are for illustrative purposes only, and that a different combination or ordering of the steps may be performed to achieve similar results. At step 710, a PMD is configured to operate as a dual-mode monitor to an existing computer setup (i.e., a computing station with an inbuilt monitor). In some instances, the existing computer setup may use a PMD as a primary monitor. As discussed above, in a dual-mode setup, the PMD operates in a clone-mode (identical display) or in an extended-mode of operation. In some instances, the touch screen feature and other “remote” operation capabilities of the PMD are disabled when the PMD operates as a duplicate monitor.

At step 715 (or in conjunction with step 710), a proximity sensor in the PMD constantly monitors a distance between the PMD and the computing station. The proximity sensor may use, for example, a pinging operation to determine the time taken for a signal to return back to the sensor to determine the distance between the PMD and the computing station. Other means by which proximity may be calculated, as understood by one of ordinary skill in the art, are equally applicable here.

At 720, the process determines whether the distance between the PMD and the computing station has exceeded a predetermined value. This may have happened when a user picks up the PMD and walks away from the location of the computing station. The predetermined value may be fixed or may be adjusted based on user preferences. If the process determines that the distance has not exceeded the predetermined value, the processing returns to step 715. Otherwise, the process proceeds to step 725, where the PMD prompts (e.g., through a display on the PMD) a set of options to the user. The set of options may include an option to allow the user to switch the PMD from a dual-mode of operation to a remote mode of operation. In an alternate embodiment, the PMD may switch directly from the dual-mode to the remote mode without prompting the user to make such a change.

At step 730, the remote operation capabilities of the PMD (e.g., touch screen capability, remote communication capabilities, etc.) are enabled such that the user can continue to operate using the remote computing station. At step 735, the process continues to monitor distance between the computing station and the PMD. At step 740, if the process determines that the PMD has moved back within the predetermined distance (e.g., when the user walks back toward the computing station), the PMD prompts another message to the user to enable the user to switch the PMD from a remote operation mode to a dual-operation mode. Again, in an alternate embodiment, the PMD may automatically switch modes without prompting the user. Subsequently, the process reverts to step 710, where the dual-mode of operation is enabled.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), etc. Software or firmware to implement the techniques introduced here may be stored on a machine-readable medium and may be executed by one or more general-purpose or special-purpose programmable microprocessors. A “machine-readable medium,” as the term is used herein, includes any mechanism that stores information in a form accessible by a machine (e.g., a computer, network device, personal digital assistant (PDA), any device with a set of one or more processors, etc.). For example, a machine-accessible medium includes recordable/non-recordable media (e.g., read-only memory (ROM), random access memory (RAM); magnetic disk storage media, optical storage media, flash memory devices, etc.).

Although the present invention has been described with reference to specific exemplary embodiments, it will be recognized that the invention is not limited to the embodiments described, but can be practiced with modification and alteration within the scope of the appended claims. Accordingly, the specification and drawings are to be regarded in an illustrative sense rather than a restrictive sense.

I claim:

1. A system for secure operation of a computing station, the system comprising:
a first computing station; and
a portable monitor system configurable to be plugged into the first computing station, the portable monitor system including:
a display component configured to output a display of the first computing station when the portable monitor system is plugged into the first computing station; and
a security component configured to uniquely associate the portable monitor system with the first computing station, wherein the first computing station allows access through the portable monitor system subsequent to the unique association based on the security component;
wherein, a user of the first computing station has access to operations of the first computing station only when the portable monitor system is plugged into the first computing station and subsequent to the unique association based on the security component.

2. The system of claim 1, wherein the portable monitor system includes a communication component configured to enable the portable monitor system to communicate with the first computing station when the portable monitor system is unplugged from the first computing station.

3. The system of claim 2, wherein the communication component enables the portable computing system to receive and display information from the first computing station subsequent to the portable display system being unplugged from the first computing station.

4. The system of claim 3, wherein the information received from the first computing station includes one or more of alerts, updates, status messages, or location indicators.

5. The system of claim 1, wherein the security component includes a hardware unit embedded in the portable monitor system.

6. The system of claim 1, wherein the portable monitor system includes an interface mechanism to allow the portable monitor system to interface with a second computing station that is adapted to recognize the security component associated with the portable monitor system.

7. A system comprising one or more portable monitor panels for distributed display of information associated with a central computer, the system comprising:
a central computer; and
a plurality of portable monitor panels remotely in communication with the central computer, each of the plurality of portable monitor panels including:
a communication component configured to enable the portable monitor panel to communicate with the central computer; and
a display unit configured to enable a user of the portable monitor panel to remotely interface with the central computer, wherein the display unit enables the user to input and/or retrieve information to/from the central computer;
wherein, the plurality of portable monitor panels are configured as portable display systems, wherein all computing operations associated with the information displayed or input through each of the plurality of portable monitor panels is executed by the central computer, and wherein each of the plurality of portable monitor panels function as input and/or output devices and do not perform computing operations related to the information that is input or output.

8. The system of claim 7, wherein a first portable monitor panel of the plurality of portable monitor panels is configured to be used as a remote monitor in addition to a stationary monitor device connected to the central computer, and wherein a display of the first portable monitor panel is independent of a display of the stationary monitor device.

9. The system of claim 7, wherein a first portable monitor panel of the plurality of portable monitor panels is configured to be used as a remote monitor in addition to a stationary monitor device connected to the central computer, and wherein a display of the first portable monitor panel is dependent on a display of the stationary monitor device.

10. The system of claim 9, wherein the display of the first portable monitor panel is one of:
a clone mode display of the display of the stationary monitor; or
an extended mode display of the display of the stationary monitor.

11. The system of claim 7, wherein a first portable monitor panel of the plurality of portable monitor panels includes a memory component.

12. The system of claim 11, wherein the memory component is configured to store data corresponding to information displayed by the first portable monitor panel, such that the data can be retrieved and displayed using the first portable monitor panel even when the first portable monitor panel is not in communication with the central computer.

13. The system of claim 12, wherein the first portable monitor panel stores the data to the memory component selectively based on specific requests from the user.

14. The system of claim 7, wherein a first portable monitor panel of the plurality of portable monitor panels is configured to be used in tandem with a second portable monitor panel of the plurality of portable monitor panels.

15. The system of claim 14, wherein a display of the first portable monitor panel is one of:
a clone mode display of a display of the second portable monitor; or
an extended mode display of the display of the second portable monitor.

16. The system of claim 7, wherein each of the plurality of portable monitor panels includes a processing component coupled to the communication component.

17. The system of claim 16, wherein the processing component of a first portable monitor panel enables the communication component of the first portable monitor panel to identify the central computer.

18. The system of claim 16, wherein the processing component of a first portable monitor panel enables the communication component of the first portable monitor panel to identify a presence of a second portable monitor panel and/or a stationary monitor device associated with the central computer.

19. The system of claim 18, wherein, when the processing component of the first portable monitor panel detects a presence of the second portable monitor panel in an immediate vicinity, the processing component enables an automatic prompt of a message in the first portable monitor panel to inform a user of the first monitor panel about the presence of the second monitor panel.

20. The system of claim 19, wherein the message provides options to the user to initiate a tandem operation of the first portable monitor panel and the second portable monitor panel, further wherein the tandem operation includes one of a clone-mode operation or an extended-mode operation of the displays of the first and second portable monitor panels.

21. The system of claim 7, wherein each of the plurality of portable monitor panels is used as a display device in a conference setting.

22. The system of claim 21, wherein each of the plurality of portable monitor panels provides an identical display based on information received by the central computer.

23. The system of claim 21, wherein a first portable monitor panel provides a display from the central computer that is different from a display provided by a second portable monitor panel.

24. The system of claim 21, wherein each of the portable monitor panels additionally function as input devices to accept input information entered by users.

25. The system of claim 7, wherein a first portable monitor panel and a second portable monitor panel of the plurality of portable monitor panels are assembled in a laptop type of arrangement to provide a user a real computer experience with just the first portable monitor and the second portable monitor.

26. The system of claim 25, wherein the first portable monitor is arranged in an upright position and is configured to receive a display corresponding to the central computer, and wherein the second portable monitor is arranged in a rested position and is configured to simulate an input unit corresponding to the central computer.

27. The system of claim 26, wherein the first portable monitor represents the display unit of the laptop type of arrangement, and the second portable monitor represents the keyboard and mouse arrangement of the laptop type of arrangement.

28. The system of claim 26, wherein the first portable monitor and the second portable monitor are attached using a hinge assembly to provide the laptop type of arrangement.

29. The system of claim 7, wherein a non-portable monitor and a first portable monitor panel of the plurality of portable monitor panels are assembled in a laptop type of arrangement to provide a user a real computer experience with just the first portable monitor and the second portable monitor, wherein the first portable monitor emulates input/output functionality based on remote communication with the central computer.

30. A system for providing remote access to a media device, the system comprising:
one or more media devices;
a portable display panel configured to provide remote access to the one or more media devices, the portable display panel including:
a communication component configured to enable the portable display panel to remotely communicate with the one or more media devices; and
a display unit configured to enable a user of the portable display panel to remotely interface with the media device, wherein the portable display unit includes a touch-screen mechanism to enable the user to input information to remotely operate the one or more media devices, and wherein the portable display unit includes a display mechanism to display information output by the one or more media devices;
wherein, the information displayed through the display mechanism includes a separate display segment corresponding to each of the one or more media devices, wherein the separate display segment corresponding to a particular media device duplicates information output by the particular media device to a display unit coupled to the particular media device, and wherein the user selects one of the separate display segments from the portable display panel to access operations related to the media device corresponding to that separate display segment.

31. The system of claim 30, wherein each of the one or more media devices include one or more of:
a personal computer;
a television system;
a home entertainment system; or
a digital recording system.

32. The system of claim 30, wherein the communication component provides a wired connection between the portable display panel and each of the one or more media devices.

33. The system of claim 30, wherein the communication component provides a wireless connection between the portable display panel and each of the one or more media devices.

34. The system of claim 30, wherein the one or more media devices includes a first media device and a second media device, further wherein the portable display panel is configured to display one of:
the display associated with only the first media device;
the display associated with only the second media device; or
the display associated with both the first and the second media devices.

35. The system of claim 34, wherein the portable display panel displays the display associated with the first media device as a picture-in-picture image within the display associated with the second media.

36. The system of claim 30, wherein the portable display panel is adapted to allow an add-in module to be fitted within a compartment in the portable display panel.

37. A method for operating multiple displays for a computing station, the method comprising:
detecting a proximity distance between a portable monitor display and a computing station, wherein the portable monitor display is configured to operate in one of two modes relative to the proximity distance, the two modes including a dual operation mode and a remote operation mode;
comparing the proximity distance against a predetermined boundary value; and
based on the proximity distance, switching the portable monitor display from the dual operation mode to the remote operation mode when the proximity distance is greater than the predetermined boundary value, or switching the portable monitor display from the remote operation mode to the dual operation mode when the proximity distance is lesser than the predetermined boundary value.

38. The method of 37, further comprising:
prompting a display to a user of the portable monitor display subsequent to detecting that the proximity distance is greater than the predetermined boundary value, wherein the prompted display enables the user to switch the portable monitor display from the dual operation mode to the remote operation mode.

39. The method of 37, further comprising:
prompting a display to a user of the portable monitor display subsequent to detecting that the proximity distance is lesser than the predetermined boundary value, wherein the prompted display enables the user to switch the portable monitor display from the remote operation mode to the dual operation mode.

40. The method of 37, further comprising:
subsequent to detecting that the proximity distance is greater than the predetermined boundary value, automatically switching the portable monitor display from the dual operation mode to the remote operation mode.

41. The method of 37, further comprising:
subsequent to detecting that the proximity distance is lesser than the predetermined boundary value, automatically switching the portable monitor display from the remote operation mode to the dual operation mode.
